(19) United States
(12) Patent Application Publication
(10) Pub. No.: US 2009/0120417 A1
(43) Pub. Date: May 14, 2009

(54) Exhaust Gas Re-Circulation Apparatus For Internal Combustion Engine

(75) Inventor: Koichiro Nakatani, Shizuoka-ken (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi-ken (JP)

(21) Appl. No.: 11/920,570

(22) PCT Filed: Jun. 13, 2006
(86) PCT No.: PCT/IB2006/001565

§ 371 Date: Nov. 16, 2007

(30) Foreign Application Priority Data
Jun. 14, 2005 (JP) 2005-173771

(51) Int. Cl. F02M 25/07

(52) U.S. Cl. 123/568.12; 123/568.21

(57) ABSTRACT

In an exhaust gas re-circulation apparatus for an internal combustion engine (1) provided with a radiator side heat carrier passage (8) having a radiator (7) provided midway therein and which opens and closes according to a thermostat (9), an EGR cooler (13) which cools exhaust gas by performing heat exchange between exhaust gas to be introduced into the intake system and a heat carrier is arranged downstream of the radiator in the radiator side heat carrier passage.

### BACKGROUND OF THE INVENTION

1. Field of the Invention

This invention relates to an exhaust gas re-circulation apparatus for an internal combustion engine, which introduces some of the exhaust gas from the internal combustion engine into an intake system of the internal combustion engine.

2. Description of the Related Art

An exhaust gas-re-circulation apparatus is known which introduces some of the exhaust gas from an internal combustion engine into an intake system of the internal combustion engine in order to reduce the NOx content of the exhaust gas that is exhausted from the internal combustion engine.

Japanese Patent Application Publication No. JP-A-2002-180914 discloses one such exhaust gas re-circulation (EGR) system which is provided with an EGR passage connecting the exhaust system with the intake system, an EGR cooler which cools exhaust gas flowing through the EGR passage, and a bypass passage which bypasses the EGR cooler. In this exhaust gas re-circulation apparatus, exhaust gas is normally introduced into the intake system via the EGR cooler, but when it is cold, the exhaust gas is introduced into the intake system via the bypass passage.

In addition, Japanese Patent Application Publication No. JP-A-2004-132180 discloses a positional arrangement of the EGR cooler in the cooling circuit. The described cooling circuit includes a first coolant passage which connects the internal combustion engine with an inlet of a radiator; a second coolant passage which connects an outlet of the radiator with a thermostat; a third coolant passage which connects a pump that pumps coolant toward the internal combustion engine with the thermostat; and a bypass coolant passage which connects the first coolant passage with the thermostat. Another coolant passage is also provided which is arranged parallel to the second and third coolant passages and connects the outlet of the radiator with the pump. The EGR cooler is disposed midway in this coolant passage.

In an internal combustion engine, when the temperature of the exhaust gas is relatively high, as it is when the engine is operating under a heavy load, the exhaust gas needs to be cooled before it is introduced into the intake system by an EGR system in order to inhibit the temperature of the air-fuel mixture in the combustion chamber from rising too high. On the other hand, when the temperature of the exhaust gas is relatively low, as it is when the engine is operating under a light load, the exhaust gas needs to be introduced into the intake system without being cooled in order to inhibit the temperature of the air-fuel mixture in the combustion chamber from dropping too low.

### SUMMARY OF THE INVENTION

This invention thus provides an exhaust gas re-circulation apparatus for an internal combustion engine which is able to more appropriately introduce exhaust gas from an internal combustion engine into the intake system.

The invention relates to an exhaust gas re-circulation apparatus for an internal combustion engine which is provided with a radiator side heat carrier passage which has a radiator arranged midway therein and which opens and closes according to a thermostat, and which has an EGR cooler arranged downstream of the radiator in the radiator side heat carrier passage.

More specifically, the exhaust gas re-circulation apparatus for an internal combustion engine according to one aspect of the invention which includes: a heat carrier circulating passage which circulates a heat carrier through the internal combustion engine; a radiator side heat carrier passage in which a radiator is arranged midway therein, both ends of the radiator side heat carrier passage being connected to the heat carrier circulating passage, the heat carrier flowing into the radiator side heat carrier passage from the end that is closer to a heat carrier outlet of the internal combustion engine and the heat carrier flowing out of the radiator side heat carrier passage from the end that is closer to a heat carrier inlet of the internal combustion engine; and a thermostat which is provided in a passage connecting portion, which is a portion of the heat carrier circulating passage that is connected with the radiator side heat carrier passage, and which closes the radiator side heat carrier passage when a temperature of the heat carrier passing through the passage connecting portion is lower than a predetermined temperature and opens the radiator side heat carrier passage when the temperature of the heat carrier passing through the passage connecting portion is equal to or higher than the predetermined temperature. The exhaust gas re-circulation apparatus further includes an EGR passage, one end of which is connected to an exhaust system of the internal combustion engine and the other end of which is connected to an intake system of the internal combustion engine, and an EGR cooler in which exhaust gas flowing through the EGR passage is cooled by heat exchange performed between exhaust gas that flows through the EGR passage and the heat carrier. The EGR cooler is arranged downstream of the radiator along the course of flow of the heat carrier in the radiator side heat carrier passage.

In this apparatus, a thermostat may be provided in the passage connecting portion which is a portion of the heat carrier circulating passage that connects with the radiator side heat carrier passage. The thermostat opens the radiator side heat carrier passage when the temperature of the heat carrier flowing through the passage connecting portion is equal to or higher than a predetermined temperature. As a result, a passage through which the heat carrier circulates through the internal combustion engine and the radiator is established so that the heat carrier can be cooled by the radiator.

For example, the predetermined temperature in this case may be a temperature of a preset value that is lower than a lower limit value of the temperature of the heat carrier at which it can be determined that there is a likelihood of the temperature of the internal combustion engine rising too high.

When the radiator side heat carrier passage is open it means that the temperature of the exhaust gas that is exhausted from the internal combustion engine is also relatively high so the exhaust gas to be introduced into the intake passage must be cooled via the EGR passage.

In the foregoing exhaust gas re-circulation apparatus, the EGR cooler that cools the exhaust gas flowing through the EGR passage is arranged downstream of the radiator along the course of flow of the heat carrier in the radiator side heat carrier passage. Therefore, when the radiator side heat carrier passage is open, heat carrier that has been cooled by the radiator flows into the EGR cooler, thus cooling the exhaust gas in the EGR cooler.

Also in this invention, the internal combustion engine, the thermostat, the radiator, and the EGR cooler are arranged in series. This configuration allows more heat carrier to be supplied to the EGR cooler than when the radiator or the thermostat and the EGR cooler are arranged parallel to one another.

That is, arranging the EGR cooler downstream of the radiator in the radiator side heat carrier passage enables heat carrier that has been cooled by the radiator to be supplied directly to the EGR cooler, as well as enables a greater amount of heat carrier to be supplied to the EGR cooler. As a result, the exhaust gas flowing through the EGR passage can be cooled more efficiently.

Also, when the temperature of the heat carrier flowing through the passage connecting portion is lower than the predetermined temperature, it means that the temperature of the exhaust gas that is exhausted from the internal combustion engine is also relatively low. In this case, the radiator side heat carrier passage is closed such that heat carrier is not supplied to the EGR cooler, which inhibits cooling of the exhaust gas flowing through the EGR passage.

That is, according to the foregoing exhaust gas re-circulation apparatus, when the exhaust gas to be introduced into the intake passage needs to be cooled, the EGR cooler can more efficiently cool that exhaust gas. In addition, when the exhaust gas that is to be introduced into the intake passage does not need to be cooled, that cooling can be inhibited.

Also, in a known apparatus, a heat carrier passage is configured such that a radiator and an EGR cooler are arranged in parallel, and a bypass passage through which exhaust gas flows so as to bypass the EGR cooler is provided in the EGR passage and a flowpath switching valve which switches the flowpath of the exhaust gas in the EGR passage is provided. In this case, the flowpath switching valve switches the flowpath such that when the exhaust gas to be introduced into the intake system needs to be cooled, it is made to flow through the EGR cooler, and when the exhaust gas to be introduced into the intake system does not need to be cooled, it is made to flow through the bypass passage. The foregoing exhaust gas re-circulation apparatus of the invention, however, makes it possible to both cool exhaust gas to be introduced into the intake system that needs to be cooled and suppress unnecessary cooling of the exhaust gas without providing such a bypass passage and flowpath switching valve.

As described above, the exhaust gas re-circulation apparatus for an internal combustion engine according to the invention enables exhaust gas from the internal combustion engine to be more appropriately introduced into the intake system.

According to the invention as described above, both ends of the radiator side heat carrier passage are connected to the heat carrier circulating passage. That is, there are passage connecting portions in two locations. In the invention, the thermostat may be provided in the passage connecting portion that is closer to the heat carrier outlet of the internal combustion engine (hereinafter referred to as the “outlet side connecting portion”).

In this case, the temperature of the heat carrier flowing into the radiator side heat carrier passage from the heat carrier circulating passage through the outlet side connecting portion, i.e., the temperature of the heat carrier flowing into the radiator, is maintained at close to a predetermined temperature. Also, when the speed of the vehicle provided with the internal combustion engine rises by an increase in load on the internal combustion engine, the heat carrier in the radiator is cooled to a greater degree the greater the load on the internal combustion engine. Therefore, when the thermostat is provided in the outlet side connecting portion, the temperature of the heat carrier flowing out from the radiator, i.e., the temperature of the heat carrier flowing into the EGR cooler, is lower the greater the load on the internal combustion engine.

The temperature of the exhaust gas rises as the load on the internal combustion engine increases. According to this configuration, however, the exhaust flowing through the EGR passage can be cooled to a greater extent the greater the load on the internal combustion engine, making it possible to more appropriately suppress an excessive rise in temperature in the combustion chamber of the internal combustion engine.

Also in the invention, the thermostat may be provided in the passage connecting portion that is closer to the heat carrier inlet of the internal combustion engine (hereinafter referred to as the “inlet side connecting portion”).

In this case, the temperature of the heat carrier flowing into the internal combustion engine is maintained at close to a predetermined temperature. Also, the temperature of the heat carrier flowing out of the internal combustion engine, i.e., the temperature of the heat carrier flowing into the radiator side heat carrier passage from the heat carrier circulating passage through the outlet side connecting portion, increases the greater the load on the internal combustion engine. That is, the temperature of the heat carrier flowing into the radiator rises as the load on the internal combustion engine increases. On the other hand, as described above, heat carrier is cooled in the radiator to a greater extent the greater the load on the internal combustion engine. Therefore, when the thermostat is provided in the outlet side connecting portion, the temperature of the heat carrier discharged from the radiator, i.e., the temperature of the heat carrier that flows into the EGR cooler, is substantially constant.

In this case, it is easier to estimate the degree to which the exhaust gas flowing through the EGR passage will be cooled by the EGR cooler, which makes it is even easier to control the fuel injection quantity and the like in the internal combustion engine.

In the exhaust gas re-circulation apparatus of the invention, an EGR valve which opens the EGR passage when a predetermined EGR condition is satisfied and closes the EGR passage when the predetermined condition is not satisfied may also be provided in the EGR passage.

The predetermined EGR condition in this case, for example, is a condition in which i) the level of NOx can be reduced by introducing some of the exhaust gas into the intake passage, and ii) it is considered unlikely that the amount of oxygen in the combustion chamber will become insufficient and the temperature in the combustion chamber will rise excessively if some of the exhaust gas were introduced into the intake passage. This predetermined EGR condition may be determined in advance through testing or the like.

When such an EGR valve is provided, a cooler bypass passage may also be provided to bypass the EGR cooler in the radiator side heat carrier passage downstream of the radiator along the course of flow of the heat carrier, and a bypass control valve may be provided in this cooler bypass passage. The bypass control valve in this case closes the cooler bypass passage when the EGR condition is satisfied and opens the cooler bypass passage when the EGR condition is not satisfied.

With this structure, the EGR passage is closed off when the predetermined EGR condition is not satisfied so there is no need to supply coolant to the EGR cooler. In this case therefore, the bypass control valve opens the cooler bypass passage so that the heat carrier bypasses the EGR cooler.

When the heat carrier is circulated bypassing the EGR cooler, the flow resistance is less than it is when the heat carrier is circulated through the EGR cooler. This structure thus make it possible to suppress an unnecessary increase in flow resistance of the flow of the heat carrier.

Also, in the exhaust gas re-circulation apparatus of the invention, a pump which pumps the heat carrier using rotation of a crankshaft of the internal combustion engine as driving force may be provided in the heat carrier circulating passage, and an EGR valve which opens the EGR passage when the internal combustion engine is operating in a predetermined operating state and closes the EGR passage when the internal combustion engine is not operating in the predetermined operating state may be provided in the EGR passage.

The predetermined operating state in this case is, for example, an operating state in which i) the level of NOx can be reduced by introducing some of the exhaust gas into the intake passage, and ii) it is considered unlikely that the amount of oxygen in the combustion chamber will become insufficient and the temperature in the combustion chamber will rise excessively if some of the exhaust gas were introduced into the intake passage. This predetermined operating state may be determined in advance through testing or the like.

When such a pump and EGR valve are provided, a cooler bypass passage may also be provided to bypass the EGR cooler in the radiator side heat carrier passage downstream of the radiator along the course of flow of the heat carrier, and a bypass control valve may be provided in this cooler bypass passage. The bypass control valve in this case closes the cooler bypass passage when a pressure of the heat carrier flowing into the cooler bypass passage is less than a predetermined bypass pressure and opens the cooler bypass passage when the pressure of the heat carrier flowing into the cooler bypass passage is equal to or greater than the predetermined bypass pressure.

With this kind of structure, heat carrier circulates through the heat carrier circulating passage by being pumped by the pump so the flowrate of the heat carrier increases the higher the speed of the internal combustion engine. Also, when the radiator side heat carrier passage is open, the flowrate of the heat carrier flowing through the radiator side heat carrier passage also increases the higher the speed of the internal combustion engine. As a result, the pressure of the heat carrier flowing into the cooler bypass passage increases.

The predetermined bypass pressure in foregoing structure is, for example, a value equal to or greater than a lower limit value of the pressure at which it can be determined that the speed of the internal combustion engine is higher than an upper limit value of the speed when the internal combustion engine is operating in the predetermined operating state.

According to this kind of structure, heat carrier is circulated through the bypass passage when the pressure of the heat carrier flowing into the cooler bypass passage is equal to or greater than the predetermined bypass pressure. That is, it is possible to inhibit heat carrier from flowing into the EGR cooler when the EGR passage is closed by the EGR valve. Accordingly, it is possible to suppress an unnecessary increase in flow resistance of the flow of the heat carrier.

In the exhaust gas re-circulation apparatus of the invention, when the foregoing EGR valve is provided in the EGR passage and the foregoing cooler bypass passage is provided in the radiator side heat carrier passage, a bypass control valve may also be provided in the cooler bypass passage. This bypass control valve closes the cooler bypass passage when the temperature of the heat carrier flowing into the cooler bypass passage is lower than a predetermined bypass temperature and opens the cooler bypass passage when the temperature of the heat carrier flowing into the cooler bypass passage is equal to or higher than the predetermined bypass temperature.

If the speed of the vehicle provided with the internal combustion engine does not increase even if the load on the internal combustion engine increases, the heat carrier is not easily cooled in the radiator so the temperature of the heat carrier circulating through the heat carrier circulating passage and the radiator side heat carrier passage rises the greater the load on the internal combustion engine. Therefore, the temperature of the heat carrier flowing into the cooler bypass passage also rises.

The predetermined bypass temperature in this case is, for example, a value equal to or greater than a lower limit value of the temperature at which it can be determined that the load on the internal combustion engine is greater than an upper limit value of the load when the internal combustion engine is operating in the predetermined operating state.

According to this structure, the heat carrier circulates through the coolant bypass passage when the temperature of the heat carrier flowing into the cooler bypass passage is equal to or higher than the predetermined bypass temperature. That is, heat carrier can be inhibited from flowing into the EGR cooler when the EGR passage is closed off by the EGR valve. Accordingly it is possible to suppress an unnecessary increase in flow resistance of the flow of the heat carrier.

In the exhaust gas re-circulation apparatus of the invention, when the foregoing pump is provided in the heat carrier circulating passage, the foregoing EGR valve is provided in the EGR passage, and the foregoing cooler bypass passage is also provided, a bypass control valve may be provided in the cooler bypass passage. This bypass control valve closes off the cooler bypass passage when the pressure of the heat carrier flowing into the cooler bypass passage is less than a predetermined bypass pressure and the temperature of the heat carrier flowing into the cooler bypass passage is lower than a predetermined bypass temperature, and opens the cooler bypass passage when the pressure of the heat carrier flowing into the cooler bypass passage is equal to or greater than the predetermined bypass pressure or when the temperature of the heat carrier flowing into the cooler bypass passage is equal to or higher than the predetermined bypass temperature.

The predetermined bypass pressure in this case is, for example, a value equal to or greater than a lower limit value of the pressure at which it can be determined that the speed of the internal combustion engine is higher than an upper limit value of the speed when the internal combustion engine is operating in the predetermined operating state. Also, as described above, the predetermined bypass temperature is, for example, a value equal to or greater than a lower limit value of the temperature at which it can be determined that the load on the internal combustion engine is greater than an upper limit value of the load when the internal combustion engine is operating in the predetermined operating state.

According to this structure, heat carrier is circulated through the cooler bypass passage when the pressure of the heat carrier flowing into the cooler bypass passage is equal to or greater than a predetermined bypass pressure and when the temperature of the heat carrier flowing into the cooler bypass passage is equal to or higher than the predetermined bypass temperature. Accordingly, it is possible to suppress an unnecessary increase in flow resistance of the flow of the heat carrier.

In this structure, the bypass control valve may also include a fixed member which is fixed to an inside wall of the cooler bypass passage, a valve body member arranged downstream of the fixed member along the course of flow of the heat carrier in the cooler bypass passage, and an expansion member, one end of which is connected to the fixed member and the other end of which is connected to the valve body member.

In this case, the coolant bypass passage is closed when the valve body member is contacting the fixed member and is open when the valve body member is separated from the fixed member.

Also, the expansion member includes a spring portion that urges the valve body member in the direction opposite the direction of flow of the heat carrier in the cooler bypass passage, and a thermal expansion portion which is formed with a substance having a larger thermal expansion coefficient than the spring portion and which pushes the valve body member in the direction of the flow of the heat carrier in the cooler bypass passage by the substance expanding when the temperature rises.

Also, the spring coefficient of the spring portion in the expansion member is a value such that, when the pressure of the heat carrier flowing into the cooler bypass passage becomes equal to or greater than the predetermined bypass pressure, the valve body member moves away from the fixed member by the pressure from the heat carrier. Further, the thermal expansion coefficient of the substance forming the thermal expansion portion of the expansion member is a value such that, when the temperature of the heat carrier flowing into the cooler bypass passage becomes equal to or higher than the predetermined bypass temperature, the valve body member moves away from the fixed member by the pressure from the thermal expansion portion.

In this kind of structure, the valve body member is brought into contact with the fixed member by the urging force of the spring portion when the pressure of the heat carrier flowing into the cooler bypass passage is less than the predetermined bypass pressure and the temperature of the heat carrier is lower than the predetermined bypass temperature. On the other hand, the valve body member is moved away from the fixed member by the pressure from the heat carrier or the pressure from the thermal expansion portion when the pressure of the heat carrier is equal to or greater than the predetermined bypass pressure or when the temperature of the heat carrier is equal to or higher than the predetermined bypass temperature.

That is, according to this structure, the bypass control valve opens the cooler bypass passage when the pressure of the heat carrier flowing into the cooler bypass passage is equal to or greater than the predetermined bypass pressure or when the temperature of the heat carrier is equal to or higher than the predetermined bypass temperature.

In the exhaust gas re-circulation apparatus of the invention, a cooler inflow control valve which cuts off the inflow of heat carrier into the EGR cooler when the cooler bypass passage is open by the bypass control valve may also be provided.

Accordingly, it is possible to inhibit heat carrier from flowing into the EGR cooler when the cooler bypass passage is open.

The exhaust gas re-circulation apparatus for an internal combustion engine according to the invention enables exhaust gas from the internal combustion engine to be more appropriately introduced into the intake system.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a schematic view showing an internal combustion engine, intake and exhaust systems, and a cooling system thereof, according to the first example embodiment of the invention;

FIG. 2 is a first view showing a temperature change in coolant running through a second coolant circulating passage;

FIG. 3 is a second view showing a temperature change in the coolant running through the second coolant circulating passage;

FIG. 4 is a schematic view showing an internal combustion engine, intake and exhaust systems, and a cooling system thereof, according to a second example embodiment of the invention;

FIG. 5 is a sectional view showing the general structure of a bypass control valve; and

FIG. 6 is a schematic view showing an internal combustion engine, intake and exhaust systems, and a cooling system thereof, according to a modified example of the second example embodiment of the invention.

### DETAILED DESCRIPTION OF THE PREFERRED EMBODIMENTS

Hereinafter, specific embodiments of the exhaust gas re-circulation apparatus for an internal combustion engine according to the invention will be described with reference to the drawings.

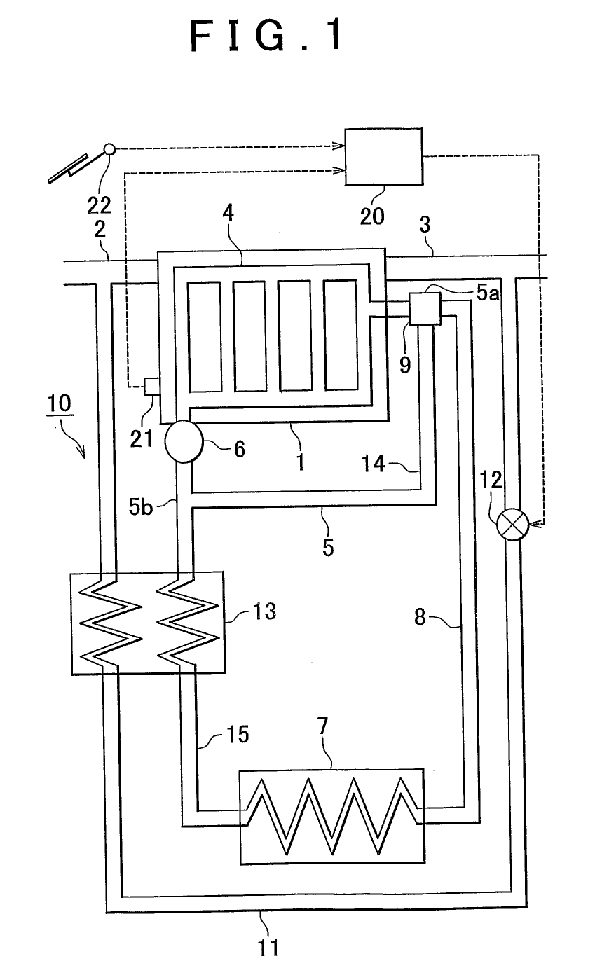

FIG. 1 is a view schematically showing the configuration of an internal combustion engine, intake and exhaust systems, and a cooling system thereof, according to the invention. An internal combustion engine 1 is a diesel engine for driving a vehicle. Both an intake passage 2 and an exhaust passage 3 are connected to the internal combustion engine 1.

A water jacket 4 through which coolant runs is also connected to the internal combustion engine 1. One end of a coolant passage 5 is connected to a coolant outlet of the water jacket 4, while the other end of the coolant passage 5 is connected to a coolant inlet of the water jacket 4. A pump 6 which pumps coolant from the coolant passage 5 side to the water jacket 4 side is provided near a portion where the coolant passage 5 connects to the coolant inlet of the water jacket 4. This pump 6 is driven by the rotation of a crankshaft of the internal combustion engine 1. Hereinafter, the passage through which coolant circulates through the water jacket 4 and the coolant passage 5 will be referred to as the “first coolant circulating passage 14”.

Both ends of a radiator side coolant passage 8, which has a radiator 7 provided midway therein, are connected to the coolant passage 5. Hereinafter, the portion of the radiator side coolant passage 8 which connects with the coolant passage 5 in the side of the coolant outlet of the water jacket 4 will be referred to as the “outlet side connecting portion 5a”. The portion of the radiator side coolant passage 8 which connects with the coolant passage 5 in the side of the coolant inlet of the water jacket 4 will be referred to as the “inlet side connecting portion 5b”.

An EGR cooler 13 which performs heat exchange between the exhaust gas flowing through an EGR passage 11, to be described later, and the coolant is provided downstream of the radiator 7 along the course of flow of the coolant in the radiator side coolant passage 8.

A thermostat 9 is provided in the outlet side connecting portion 5a. This thermostat 9 closes the radiator side coolant passage 8 when the temperature of the coolant flowing through the outset side connecting portion 5a is lower than a predetermined temperature, and opens the radiator side coolant passage 8 when the temperature of the coolant is equal to or higher than the predetermined temperature. The predetermined temperature in this case is a preset value that is lower than a lower limit value of the temperature of the coolant at which it can be determined that there is a likelihood of the temperature of the internal combustion engine 1 rising too high.

When the thermostat 9 opens the radiator side coolant passage 8, a passage is established which enables coolant to circulate through the internal combustion engine 1, the radiator side coolant passage 8, the radiator 7, and the EGR cooler 13. Hereinafter this passage will be referred to as the “second coolant circulating passage 15”.

The internal combustion engine 1 is provided with an exhaust gas re-circulation apparatus 10 (hereinafter referred to as “EGR system 10”) which introduces some of the exhaust gas flowing through the exhaust passage 3 into the intake passage 2. This EGR system 10 includes an EGR passage 11, one end of which is connected to the exhaust passage 3 and the other end of which is connected to the intake passage 2, and an EGR valve 12 and the EGR cooler 13 both provided midway in the EGR passage 11.

Opening the EGR valve 12 opens the EGR passage 11 such that some of the exhaust gas flows into the intake passage 2 through the EGR passage 11. Closing the EGR valve 12 on the other hand closes the EGR passage 11. Also, heat transfer between coolant flowing through the radiator side coolant passage 8 and exhaust gas flowing through the EGR passage 11 is performed in the EGR cooler 13. This heat transfer serves to cool the exhaust gas to be introduced into the intake passage 2.

The internal combustion engine 1 is also provided with an electronic control unit (ECU) 20 for controlling the internal combustion engine 1. This ECU 20 controls the operating state of the internal combustion engine 1 based on operating conditions of the internal combustion engine 1 and requests from the driver. The ECU 20 is electrically connected to a crankshaft position sensor 21 which outputs an electrical signal corresponding to the rotation angle of a crankshaft of the internal combustion engine 1, as well as an accelerator opening amount sensor 22 which outputs an electrical signal corresponding to an accelerator opening amount of the vehicle provided with the internal combustion engine 1. The output signals from these sensors are input to the ECU 20 which then derives the speed of the internal combustion engine 1 based on the output value of the crankshaft position sensor 21, and the load on the internal combustion engine 1 based on the output value from the accelerator opening amount sensor 22.

The ECU 20 is also electrically connected to the EGR valve 12 which is controlled by the ECU 20. In this example embodiment, the ECU 20 opens the EGR valve 12 when the internal combustion engine 1 is operating in a predetermined operating state, and closes the EGR valve 12 when the internal combustion engine 1 is not operating in the predetermined operating state.

The predetermined operating state in this case is an operating state in which i) the level of NOx can be reduced by introducing some of the exhaust gas into the intake passage 2, and ii) it is considered unlikely that the amount of oxygen in the combustion chamber will become insufficient and the temperature in the combustion chamber will rise excessively if some of the exhaust gas were introduced into the intake passage 2. This predetermined operating state is determined in advance through testing or the like.

In this example embodiment, when the temperature of the coolant flowing through the outlet side connecting portion 5a in the coolant passage 5 reaches the predetermined temperature, the thermostat 9 opens the radiator side coolant passage 8, establishing the second coolant circulating passage 15 such that coolant is cooled by the radiator 7.

When the radiator side coolant passage 8 is open it means that the temperature of the exhaust gas that is exhausted from the internal combustion engine 1 is relatively high so the exhaust gas to be introduced into the intake passage 2 must be cooled via the EGR passage 11.

In this example embodiment, the EGR cooler 13 that cools the exhaust gas flowing through the EGR passage 11 is arranged downstream of the radiator 7 along the course of flow of the coolant in the radiator side coolant passage 8. Therefore, when the radiator side coolant passage 8 is open, coolant that has been cooled by the radiator 7 flows into the EGR cooler 13, thus cooling the exhaust gas in the EGR cooler 13.

Also in this example embodiment, the internal combustion engine 1, the thermostat 9, the radiator 7, and the EGR cooler 13 are arranged in series. This configuration allows more coolant to be supplied to the EGR cooler 13 than when the radiator 7 or the thermostat 9 and the EGR cooler 13 are arranged parallel to one another.

That is, arranging the EGR cooler 13 downstream of the radiator 7 in the radiator side coolant passage 8 enables coolant that has been cooled by the radiator 7 to be supplied directly to the EGR cooler 13, as well as enables a greater amount of coolant to be supplied to the EGR cooler 13. As a result, the exhaust gas flowing through the EGR passage 11 can be cooled more efficiently.

Also, if the temperature of the coolant flowing through the outlet side connecting portion 5a is lower than the predetermined temperature, then the temperature of the exhaust gas that is exhausted from the internal combustion engine 1 is relatively low. In this example embodiment, the radiator side coolant passage 8 in this case is closed so that coolant is not supplied to the EGR cooler 13, which inhibits cooling of the exhaust gas that flows through the EGR passage 11.

That is, according to this example embodiment, when the exhaust gas to be introduced into the intake passage 2 needs to be cooled, the EGR cooler 13 can more efficiently cool that exhaust gas. In addition, when the exhaust gas that is to be introduced into the intake passage 2 does not need to be cooled, that cooling can be inhibited.

Also according to this example embodiment, there is no need to provide either a bypass passage through which the exhaust gas flows to bypass the EGR cooler 13, or a flowpath switching valve that switches between a position that makes the exhaust gas flowing through the EGR passage 11 flow through the bypass passage and a position that makes that exhaust gas flow through the EGR cooler 13.

As described above, the example embodiment is thus able to more appropriately introduce exhaust gas from the internal combustion engine 1 into the intake passage.

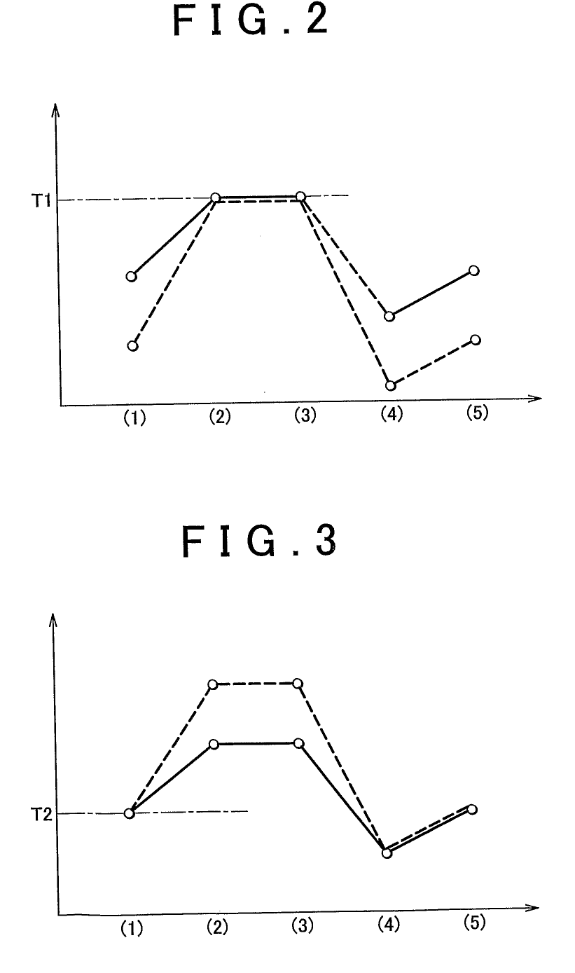

In this example embodiment, the thermostat 9 is provided in the outlet side connecting portion 5a. A change in the temperature of the coolant flowing through the second coolant circulating passage 15 with this configuration will now be described with reference to FIG. 2. The vertical axis in the drawing represents the temperature of the coolant and the numbers (1) to (5) along the horizontal axis represent positions in the second coolant circulating passage, with (1) representing the coolant inlet of the water jacket 4, (2) representing the coolant outlet of the water jacket 4, (3) representing the coolant inlet of the radiator 7, (4) representing the coolant outlet of the radiator 7 (i.e., the coolant inlet of the EGR cooler 13), and (5) representing the coolant outlet of the EGR cooler 13. Also, the solid line in the drawing represents a temperature change in the coolant when the internal combustion engine is operating under a light load, and the broken like represents a temperature change in the coolant when the internal combustion engine is operating under a heavy load. T1 in the drawing represents a predetermined temperature when the thermostat 9 is provided in the outlet side connecting portion 5a.

When the thermostat 9 is provided in the outlet side connecting portion 5a, as shown at (2) in FIG. 2, the temperature of the coolant that is discharged from the water jacket 4 is maintained at close to the predetermined temperature T1 regardless of the load on the internal combustion engine 1. Therefore, as shown at (3) in the same drawing, the temperature of the coolant that flows into the radiator side coolant passage 8 through the outlet side connecting portion 5a, i.e., the temperature of the coolant flowing into the radiator 7, is also maintained at close to the predetermined temperature T1.

In the radiator 7, the coolant is cooled to a greater extent as the load on the internal combustion engine 1 increases and the speed of the vehicle provided with the internal combustion engine 1 rises. Therefore as shown at (4) in FIG. 2, the temperature of the coolant flowing out of the radiator 7, i.e., the temperature of the coolant flowing into the EGR cooler 13, decreases as the load on the internal combustion engine 1 increases.

The temperature of the exhaust rises as the load on the internal combustion engine 1 increases. According to this example embodiment, however, the exhaust gas flowing through the EGR passage 11 can be cooled to a greater extent as the load on the internal combustion engine 1 increases, which makes it possible to more appropriately suppress an excessive rise in temperature in the combustion chamber of the internal combustion engine 1.

### Modified Example

In the example embodiment, the thermostat 9 may also be provided in the inlet side connecting portion 5b. A change in the temperature of the coolant flowing through the second coolant circulating passage 15 with this configuration will now be described with reference to FIG. 3. Just as in FIG. 2, the vertical axis in FIG. 3 represents the temperature of the coolant and the numbers (1) to (5) along the horizontal axis represent positions in the second coolant circulating passage, with (1) representing the coolant inlet of the water jacket 4, (2) representing the coolant outlet of the water jacket 4, (3) representing the coolant inlet of the radiator 7, (4) representing the coolant outlet of the radiator 7 (i.e., the coolant inlet of the EGR cooler 13), and (5) representing the coolant outlet of the EGR cooler 13. Also similar to FIG. 2, in FIG. 3 the solid line represents a temperature change in the coolant when the internal combustion engine is operating under a light load, and the broken like represents a temperature change in the coolant when the internal combustion engine is operating under a heavy load. T2 in the FIG. 3 represents a predetermined temperature when the thermostat 9 is provided in the inlet side connecting portion 5b.

When the thermostat 9 is provided in the inlet side connecting portion 5b, as is shown at (1) in FIG. 3, the temperature of the coolant flowing into the water jacket 4 is maintained at close to the predetermined temperature T2 regardless of the load on the internal combustion engine 1. Therefore, as shown at (2) in the same drawing, the temperature of the coolant that flows out of the water jacket 4 is higher the greater the load on the internal combustion engine 1. Accordingly, the temperature of the coolant that flows into the radiator side coolant passage 8 through the outlet side connecting portion 5a is also higher the greater the load on the internal combustion engine 1. Therefore, as shown at (3) in FIG. 3, the temperature of the coolant flowing into the radiator 7 is higher the greater the load on the engine 1. On the other hand, as described above, coolant is cooled in the radiator 7 to a greater extent the greater the load on the internal combustion engine 1. Therefore, as shown at (4) in the drawing, the temperature of the coolant discharged from the radiator 7, i.e., the temperature of the coolant that flows into the EGR cooler 13, is substantially constant regardless of the load on the internal combustion engine 1.

In this case, it is easier to estimate the degree to which the exhaust gas flowing through the EGR passage 11 will be cooled by the EGR cooler 13, which makes it is even easier to control the fuel injection quantity and the like in the internal combustion engine 1.

### Second Example Embodiment

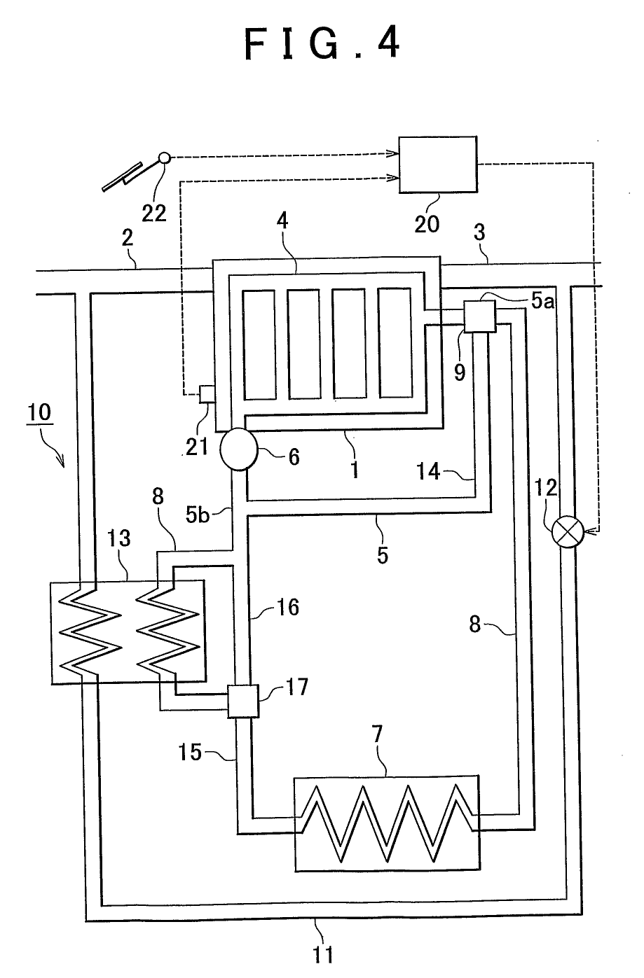

FIG. 4 shows the schematically shows the configuration of an internal combustion engine, intake and exhaust systems, and a cooling system thereof, according to a second example embodiment. In this example embodiment, a cooler bypass passage 16 which bypasses the EGR cooler 13 is provided downstream of the radiator 7 in the radiator side coolant passage 8. In addition, a bypass control valve 17 is provided in a connecting portion which connects the upstream side of the cooler bypass passage 16 with the upstream side of the radiator side coolant passage 8. This bypass control valve 17 selectively opens and closes the cooler bypass passage 16. The other structure is the same as that in the first example embodiment described above so like portions will be denoted by like reference numerals and descriptions thereof will be omitted.

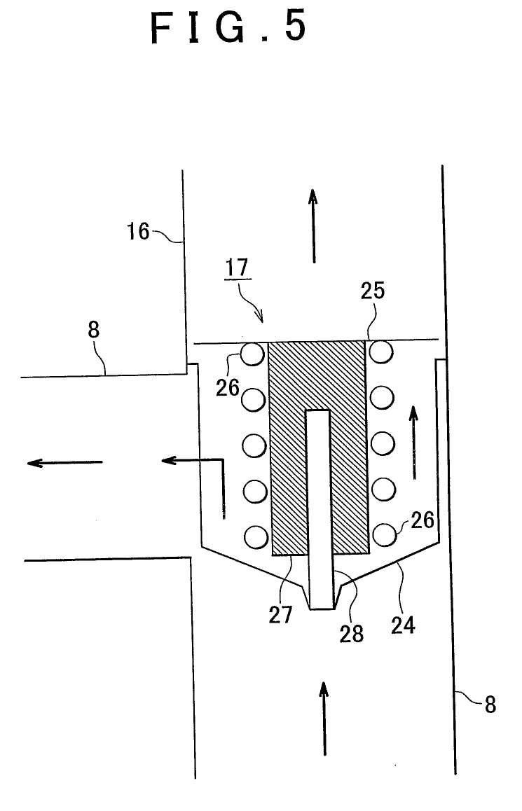

Next, the general structure of the bypass control valve 17 according to this example embodiment will be described with reference to FIG. 5 which is a sectional view of the general structure of the bypass control valve 17. The arrows in the drawing indicate the direction of flow of the coolant.

The bypass control valve 17 includes a fixed member 24 which is fixed to an inside wall of the cooler bypass passage 16, and a valve body member 25 which is arranged on the downstream side of the fixed member 24 along the course of flow of the coolant in the cooler bypass passage 16. When the valve body member 25 is contacting the fixed member 24, the cooler bypass passage 16 is closed. On the other hand, when the valve body member 25 is separated from the fixed member 24, the cooler bypass passage 16 is open.

The bypass control valve 17 also has a spring 26, a wax housing portion 27, and a needle 28. One end of the spring 26 is connected to the fixed member 24 and the other end is connected to the valve body member 25. The spring 26 urges the valve body member 25 in the direction opposite the direction of flow of the coolant in the cooler bypass passage 16. That is, the urging force of the spring 26 works to bring the valve body member 25 into contact with the fixed member 24.

Meanwhile, the wax housing portion 27 is connected to the valve body member 25 and houses wax inside. The wax is a substance that has a larger thermal expansion coefficient than the spring 26. Also, one end of the needle 28 is inserted into the wax housing portion 27, while the other end of the needle 28 is connected to the fixed portion 24. With this kind of structure, the wax inside the wax housing portion 27 expands when the temperature rises, which pushes the valve body member 25 in the direction of flow of the coolant in the cooler bypass passage 16. That is, when the pressure generated by the expanding wax reaches or exceeds a certain pressure, the valve body member 25 moves away from the fixed member 24.

The spring coefficient of the spring 26 is a value that allows the valve body member 25 to move away from the fixed member 24 from the pressure of the coolant when the pressure of the coolant passing through the bypass control valve 17 reaches or exceeds a predetermined bypass pressure. Also, the thermal expansion coefficient of the wax inside the wax housing portion 27 is a value that enables the valve body member 25 to move away from the fixed member 24 from the pressure generated by the expansion of the wax when the temperature of the coolant passing through the bypass control valve 17 reaches or exceeds the predetermined bypass temperature.

Hereinafter, the predetermined bypass pressure and the predetermined bypass temperature will be described. In this example embodiment, coolant circulates through the first and second coolant circulating passages 14 and 15 by being pumped by the pump 6 that is driven by the rotation of the crankshaft of the internal combustion engine 1. Therefore, the flowrate of the coolant increases the higher the speed of the internal combustion engine 1. Accordingly, the pressure of the coolant flowing into the cooler bypass passage 16, i.e., the pressure of the coolant passing through the bypass control valve 17, increases as the speed of the internal combustion engine 1 increases.

Also, even if the load on the internal combustion engine 1 increases, if the speed of the vehicle provided with the internal combustion engine 1 does not increase, the coolant is not easily cooled in the radiator 7. In this case therefore, the temperature of the coolant circulating through the first and second coolant circulating passages 14 and 15 rises the greater the load on the internal combustion engine 1. With this rise in temperature, the temperature of the coolant flowing into the cooler bypass passage 16, i.e., the temperature of the coolant passing through the bypass control valve 17 also rises.

As described above, the EGR passage 11 is open when the internal combustion engine 1 is operating in a predetermined operating state. In other words, the EGR passage 11 is closed when the internal combustion engine 1 is not operating in the predetermined operating state. In this case, it is not necessary to supply coolant to the EGR cooler.

Thus, in this example embodiment, the predetermined bypass pressure is set at a value equal to or greater than a lower limit value of the pressure at which it can be determined that the speed of the internal combustion engine 1 is higher than the speed when the internal combustion engine 1 is operating in the predetermined operating state. Also, the predetermined bypass temperature is set at a value equal to or greater than a lower limit value of the temperature at which it can be determined that the load on the internal combustion engine 1 is greater than the load when the internal combustion engine 1 is operating in the predetermined operating state.

According to this kind of structure, coolant is circulated through the cooler bypass passage 16 when the pressure of the coolant passing through the bypass control valve 17 is equal to or greater than the predetermined bypass pressure, and when the temperature of the coolant passing through the bypass control valve 17 is equal to or greater than the predetermined bypass temperature. That is, it is possible to inhibit coolant from flowing into the EGR cooler when the EGR passage 11 is closed by the EGR valve 12.

When coolant is circulated bypassing the EGR cooler 13, the flow resistance is less than it is when coolant is circulated through the EGR cooler 13. Thus, according to this example embodiment, it is possible to suppress an unnecessary increase in flow resistance of the flow of the coolant.

### First Modified Example

In the example embodiment, the bypass control valve 17 may also be a relief valve which opens the cooler bypass passage 16 when the pressure of the coolant passing through the bypass control valve 17 is equal to or greater than the predetermined bypass pressure.

In this case as well, coolant is circulated through the cooler bypass passage 16 when the pressure of the coolant passing through the bypass control valve 17 is equal to or greater than the predetermined bypass pressure. As a result, it is possible to inhibit coolant from flowing into the EGR cooler when the EGR passage 11 is closed by the EGR valve 12. Accordingly, an unnecessary increase in flow resistance of the flow of the coolant is able to be suppressed.

### Second Modified Example

In the example embodiment, the bypass control valve 17 may alternatively be a thermostat that opens the cooler bypass passage 16 when the temperature of the coolant passing through the bypass control valve 17 becomes equal to or greater than the predetermined bypass temperature.

In this case as well, coolant is circulated through the cooler bypass passage 16 when the temperature of the coolant passing through the bypass control valve 17 is equal to or greater than the predetermined bypass temperature. As a result, it is possible to inhibit coolant from flowing into the EGR cooler when the EGR passage 11 is closed by the EGR valve 12. Accordingly, an unnecessary increase in flow resistance of the flow of the coolant is able to be suppressed.

### Third Modified Example

The bypass control valve 17 may alternatively be an electromagnetic valve that is controlled by the ECU 20. In this case, the ECU 20 opens the bypass control valve 17 which opens the cooler bypass passage 16 when the internal combustion engine 1 is operating in the predetermined operating state.

In this case as well, it is possible to inhibit coolant from flowing into the EGR cooler when the EGR passage 11 is closed by the EGR valve 12. Accordingly, an unnecessary increase in flow resistance of the flow of the coolant is able to be suppressed.

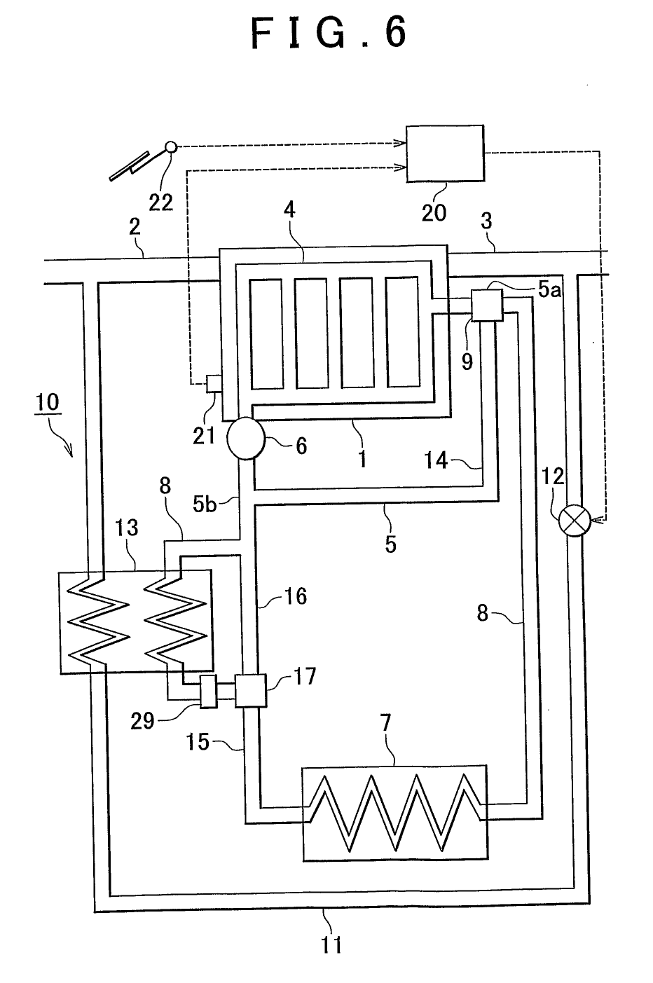

In the example embodiment, as shown in FIG. 6, a cooler inflow control valve 29 which controls the inflow of coolant into the EGR cooler 13 may also be provided in a location in the radiator side coolant passage 8 which is upstream of the EGR cooler 13 and downstream of the connecting portion where the radiator side coolant passage 8 connects with the cooler bypass passage 16.

In this case, when the cooler bypass passage 16 is opened by the bypass control valve 17 opening, the cooler inflow control valve closes, thus cutting off the inflow of coolant to the EGR cooler 13. Accordingly, it is possible to inhibit coolant from flowing into the EGR cooler when the cooler bypass passage 16 is open.

While the invention has been described with reference to exemplary embodiments thereof, it is to be understood that the invention is not limited to the exemplary embodiments or constructions. To the contrary, the invention is intended to cover various modifications and equivalent arrangements other than described above. In addition, while the various elements of the exemplary embodiments are shown in various combinations and configurations, which are exemplary, other combinations and configurations, including more, less or only a single element, are also within the spirit and scope of the invention.

1. An exhaust gas re-circulation apparatus for an internal combustion engine, comprising:
a heat carrier circulating passage which circulates a heat carrier through the internal combustion engine;
a radiator side heat carrier passage in which a radiator is arranged midway therein, both ends of the radiator side heat carrier passage being connected to the heat carrier circulating passage, the heat carrier flowing into the radiator side heat carrier passage from the end that is closer to a heat carrier outlet of the internal combustion engine and the heat carrier flowing out of the radiator side heat carrier passage from the end that is closer to a heat carrier inlet of the internal combustion engine; and
a thermostat which is provided in a passage connecting portion, which is a portion of the heat carrier circulating passage that is connected with the radiator side heat carrier passage, and which closes the radiator side heat carrier passage when a temperature of the heat carrier passing through the passage connecting portion is lower than a predetermined temperature and opens the radiator side heat carrier passage when the temperature of the heat carrier passing through the passage connecting portion is equal to or higher than the predetermined temperature,
an EGR passage, one end of which is connected to an exhaust system of the internal combustion engine and the other end of which is connected to an intake system of the internal combustion engine;
an EGR cooler in which exhaust gas flowing through the EGR passage is cooled by heat exchange performed between exhaust gas that flows through the EGR passage and the heat carrier, the EGR cooler being arranged downstream of the radiator along the course of flow of the heat carrier in the radiator side heat carrier passage
an EGR valve provided in the EGR passage, which opens the EGR passage when a predetermined EGR condition is satisfied and closes the EGR passage when the predetermined condition is not satisfied;
a cooler bypass passage provided so as to bypass the EGR cooler in the radiator side heat carrier passage downstream of the radiator along the course of flow of the heat carrier; and
a bypass control valve provided in the cooler bypass passage, which closes off the cooler bypass passage when the predetermined EGR condition is satisfied and opens the cooler bypass passage when the predetermined EGR condition is not satisfied.

2. The exhaust gas re-circulation apparatus according to claim 1, wherein the thermostat is provided in the passage connecting portion which is closer to the heat carrier outlet of the internal combustion engine.

3. The exhaust gas re-circulation apparatus according to claim 1, wherein the thermostat is provided in the passage connecting portion which is closer to the heat carrier inlet of the internal combustion engine.

4. (canceled)

5. The exhaust gas re-circulation apparatus according to claim 1, further comprising:
a pump which is provided in the heat carrier circulating passage and which pumps the heat carrier using rotation of a crankshaft of the internal combustion engine as driving force, wherein
the EGR valve opens the EGR passage when the internal combustion engine is operating in a predetermined operating state and closes the EGR passage when the internal combustion engine is not operating in the predetermined operating state, and wherein
the bypass control valve closes off the cooler bypass passage when a pressure of the heat carrier flowing into the cooler bypass passage is less than a predetermined bypass pressure and opens the cooler bypass passage when the pressure of the heat carrier flowing into the cooler bypass passage is equal to or greater than the predetermined bypass pressure.

6. The exhaust gas re-circulation apparatus according to claim 1, wherein
the EGR valve opens the EGR passage when the internal combustion engine is operating in a predetermined operating state and closes the EGR passage when the internal combustion engine is not operating in the predetermined operating state, and wherein
the bypass control valve closes off the cooler bypass passage when a temperature of the heat carrier flowing into the cooler bypass passage is lower than a predetermined bypass temperature and opens the cooler bypass passage when the temperature of the heat carrier flowing into the cooler bypass passage is equal to or higher than the predetermined bypass temperature.

7. The exhaust gas re-circulation apparatus according to claim 1, further comprising:
a pump which is provided in the heat carrier circulating passage and which pumps the heat carrier using rotation of a crankshaft of the internal combustion engine as driving force, wherein
the EGR valve opens the EGR passage when the internal combustion engine is operating in a predetermined operating state and closes the EGR passage when the internal combustion engine is not operating in the predetermined operating state, and wherein
the bypass control valve closes off the cooler bypass passage when a pressure of the heat carrier flowing into the cooler bypass passage is less than a predetermined bypass pressure and a temperature of the heat carrier flowing into the cooler bypass passage is lower than a predetermined bypass temperature, and opens the cooler bypass passage when the pressure of the heat carrier flowing into the cooler bypass passage is equal to or greater than the predetermined bypass pressure or when the temperature of the heat carrier flowing into the cooler bypass passage is equal to or higher than the predetermined bypass temperature.

8. The exhaust gas re-circulation apparatus according to claim 7, wherein:
the bypass control valve includes a fixed member which is fixed to an inside wall of the cooler bypass passage; a valve body member which is arranged downstream of the fixed member along the course of flow of the heat carrier in the cooler bypass passage and which closes off the cooler bypass passage when contacting the fixed member and opens the cooler bypass passage when separated from the fixed member; and an expansion member, one end of which is connected to the fixed member and the other end of which is connected to the valve body member;
the expansion member includes a spring portion that urges the valve body member in the direction opposite the direction of flow of the heat carrier in the cooler bypass passage, and a thermal expansion portion which is formed including a substance having a larger thermal expansion coefficient than the spring portion and which pushes the valve body member in the direction of the flow of the heat carrier in the cooler bypass passage by the substance expanding when the temperature rises; and
a spring coefficient of the spring portion of the expansion member is a value such that, when the pressure of the heat carrier flowing into the cooler bypass passage is equal to or greater than the predetermined bypass pressure, the valve body member moves away from the fixed member by pressure from the heat carrier; and a thermal expansion coefficient of the substance forming the thermal expansion portion of the expansion member is a value such that, when the temperature of the heat carrier flowing into the cooler bypass passage is equal to or greater than the predetermined bypass temperature, the valve body member moves away from the fixed member by pressure from the thermal expansion portion.

9. The exhaust gas re-circulation apparatus according to claim 1, further comprising:
a cooler inflow control valve which cuts off the inflow of the heat carrier into the EGR cooler when the cooler bypass passage is opened by the bypass control valve.
